(19) United States
(12) Patent Application Publication
(10) Pub. No.: US 2026/0088229 A1
(43) Pub. Date: Mar. 26, 2026

(54) MULTILAYER CERAMIC CAPACITOR

(71) Applicant: Murata Manufacturing Co., Ltd., Nagaokakyo-shi (JP)

(72) Inventor: Hiroaki SUGITA, Nagaokakyo-shi (JP)

(21) Appl. No.: 19/297,072

(22) Filed: Aug. 12, 2025

(30) Foreign Application Priority Data
Sep. 24, 2024 (JP) 2024-165264

(51) Int. Cl. H01G 4/30; H01G 4/008; H01G 4/012

(52) U.S. Cl. CPC H01G 4/30; H01G 4/0085; H01G 4/012

(57) ABSTRACT

A multilayer ceramic capacitor includes an inner layer portion including inner dielectric layers and internal electrode layers alternately laminated in a lamination direction. The internal electrode layers include a first outer internal electrode layer closest to one of two main surfaces and a second outer internal electrode layer opposed to the first outer internal electrode layer, and a line coverage at an end portion in a width direction of the first outer internal electrode layer is lower than a line coverage at an end portion in the width direction of the second outer internal electrode layer. The first outer internal electrode layer further includes a divided region at the end portion where Mg or Mn is segregated.

### CROSS REFERENCE TO RELATED APPLICATIONS

This application claims the benefit of priority to Japanese Patent Application No. 2024-165264 filed on Sep. 24, 2024. The entire contents of this application are hereby incorporated herein by reference.

### BACKGROUND OF THE INVENTION

### 1. Field of the Invention The present invention relates to multilayer ceramic capacitors.

### 2. Description of the Related Art

In the prior art, multilayer ceramic capacitors each include a multilayer body in which dielectric layers and internal electrode layers are alternately laminated, and dielectric layers are further laminated on the upper and lower surfaces thereof, and a pair of external electrodes each provided on one end surfaces of the multilayer body. The internal electrode layers include counter electrode portions that generate capacitance and extension electrode portions that extend from the counter electrode portions toward the external electrodes.

In recent years, with the advancement of electronics technology, in order to reduce the size and increase the capacitance of each multilayer ceramic capacitor, technological development is being promoted to reduce the thickness of dielectric layers and internal electrode layers and increase the number of dielectric layers and internal electrode layers to be laminated (See, for example, Japanese Unexamined Patent Application, Publication No. 2001-237137).

However, when the thickness of the dielectric layers and internal electrode layers is reduced, it becomes difficult to form an appropriate layer configuration, and breaks in the dielectric layers or internal electrode layers are likely to occur. In particular, at the end portions of the multilayer body, since pressure is applied during manufacturing, the continuity of the internal electrode layers tends to be low, which tends to be a factor that reduces the high-temperature reliability of each of the multilayer ceramic capacitors.

### SUMMARY OF THE INVENTION

Example embodiments of the present invention provide multilayer ceramic capacitors each with high high-temperature reliability and reduced size and increased capacitance.

The inventor of example embodiments of the present invention has discovered that the high-temperature reliability of multilayer ceramic capacitors is improved by lowering the line coverage at the end portions in the width direction of the first outer internal electrode layer closest to the main surface of the multilayer body and segregating specific metal components in the divided regions at the end portions in the width direction of the first outer internal electrode layer.

An example embodiment of the present invention provides a multilayer ceramic capacitor which includes a multilayer body including an inner layer portion including a plurality of inner dielectric layers and a plurality of internal electrode layers alternately laminated in a lamination direction, and outer layer portions sandwiching the inner layer portion in the lamination direction, the multilayer body including two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction, and a pair of external electrodes each on a corresponding one of the two end surfaces and each connected to the plurality of internal electrode layers, in which the plurality of internal electrode layers include a first outer internal electrode layer closest to one of the two main surfaces and a second outer internal electrode layer that is opposed to the first outer internal electrode layer, and a line coverage at an end portion in the width direction of the first outer internal electrode layer is lower than a line coverage at an end portion in the width direction of the second outer internal electrode layer, and the first outer internal electrode layer further includes a divided region at the end portion where Mg or Mn is segregated.

According to example embodiments of the present invention, it is possible to provide multilayer ceramic capacitors each with high high-temperature reliability and reduced size and increased capacitance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view showing a multilayer ceramic capacitor according to an example embodiment of the present invention.

FIG. 2 is a cross-sectional view taken along the line II-II (LT cross-section) of the multilayer ceramic capacitor shown in FIG. 1.

FIG. 3 is a cross-sectional view taken along the line III-III (WT cross-section) of the multilayer ceramic capacitor shown in FIG. 1.

FIG. 4 is a schematic diagram showing the configuration of an inner layer portion of the multilayer ceramic capacitor shown in FIG. 1.

FIG. 5 is an enlarged view of a region V shown in FIG. 3.

### DETAILED DESCRIPTION OF THE EXAMPLE EMBODIMENTS

Hereinafter, example embodiments of the multilayer ceramic capacitor of the present invention will be described in detail with reference to the drawings, but the present invention is not limited thereto. The drawings may be schematically simplified to explain the content of the present invention, and the ratio of dimensions of the components or between components shown in the drawings may not match the ratio of dimensions described in the specification. Also, components described in the specification may be omitted in the drawings, or the number of components may be reduced in the drawings.

### Multilayer Ceramic Capacitor

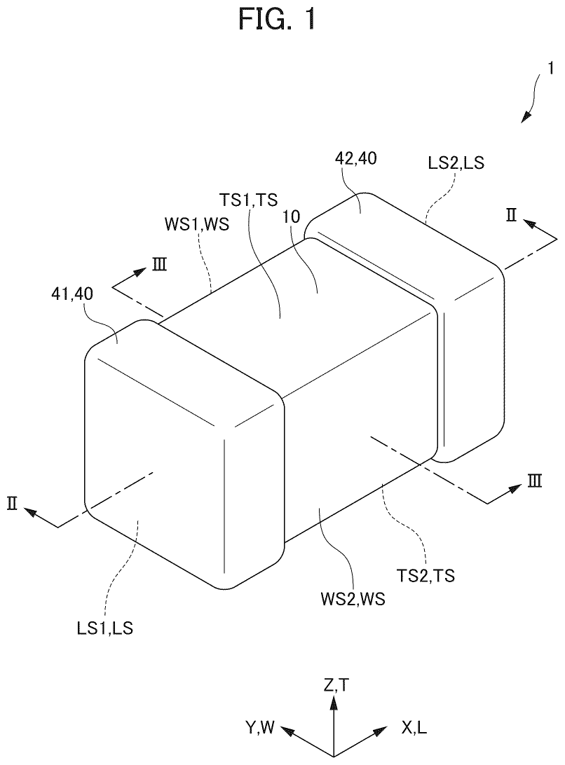

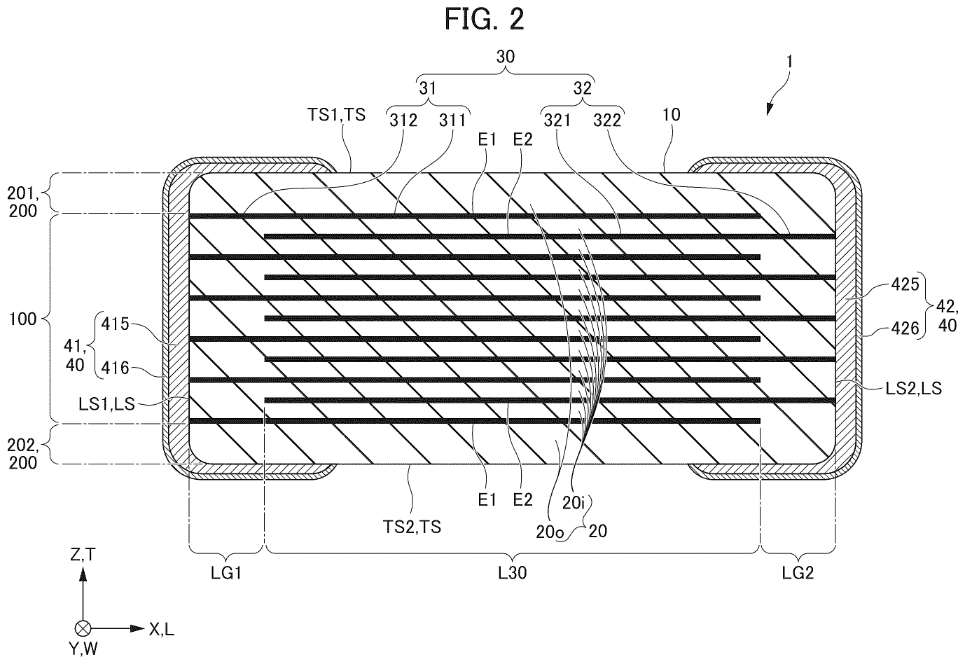

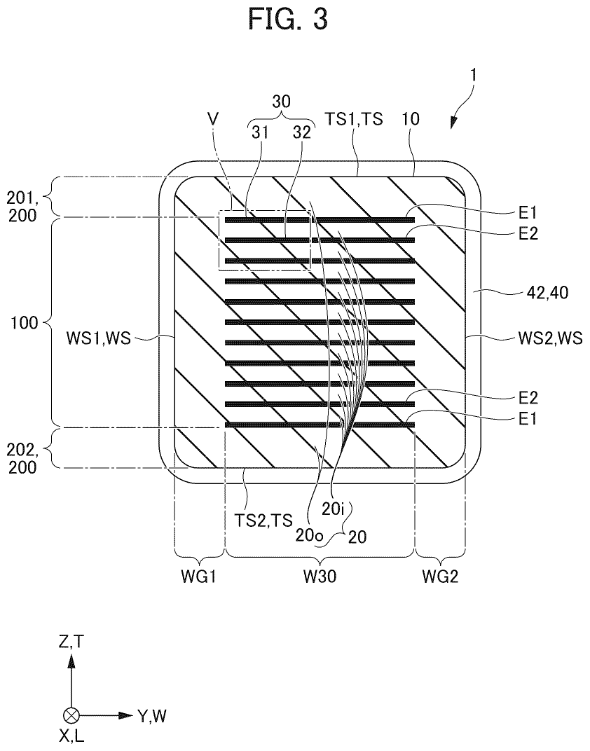

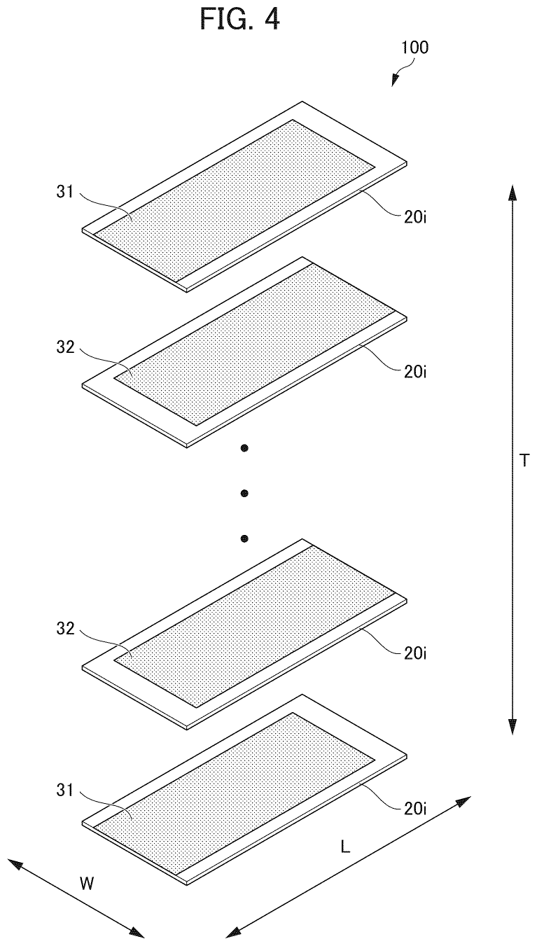

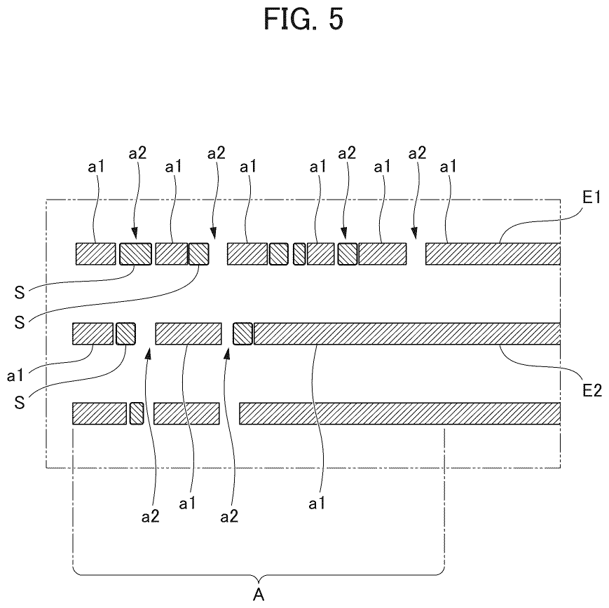

FIG. 1 is a perspective view showing a multilayer ceramic capacitor according to an example embodiment of the present invention. FIG. 2 is a cross-sectional view taken along the line II-II of the multilayer ceramic capacitor shown in FIG. 1. FIG. 3 is a cross-sectional view taken along the line III-III of the multilayer ceramic capacitor shown in FIG. 1. FIG. 4 is a schematic diagram showing the configuration of an inner layer portion of the multilayer ceramic capacitor shown in FIG. 1. FIG. 5 is an enlarged view of a region V shown in FIG. 3. The multilayer ceramic capacitor 1 shown in FIGS. 1 to 5 includes a multilayer body 10 and external electrodes 40. The external electrodes 40 include a first external electrode 41 and a second external electrode 42.

FIGS. 1 to 3 show an XYZ Cartesian coordinate system. The X direction refers to the length direction L of the multilayer ceramic capacitor 1 and the multilayer body 10, the Y direction refers to the width direction W of the multilayer ceramic capacitor 1 and the multilayer body 10, and the Z direction refers to the lamination direction T of the multilayer ceramic capacitor 1 and the multilayer body 10. Accordingly, the cross-section shown in FIG. 2 is also referred to as an LT cross-section, and the cross-section shown in FIG. 3 is also referred to as a WT cross-section. In addition, the length direction L, the width direction W, and the lamination direction T are not necessarily orthogonal or substantially orthogonal to each other, and it suffices if they intersect with each other.

It is preferable that the multilayer ceramic capacitor has, for example, a dimension in the length direction L of about 0.2 mm or more and about 10 mm or less, a dimension in the width direction W of about 0.1 mm or more and about 10 mm or less, and a dimension in the lamination direction T of about 0.1 mm or more and about 10 mm or less.

### Multilayer Body

The multilayer body 10 has a rectangular or substantially rectangular parallelepiped shape and includes a first main surface TS1 and a second main surface TS2 opposed to each other in the lamination direction T, a first lateral surface WS1 and a second lateral surface WS2 opposed to each other in the width direction W, and a first end surface LS1 and a second end surface LS2 opposed to each other in the length direction L. The surfaces may include unevenness or may be roughened. When there is no need to particularly distinguish between the first main surface TS1 and the second main surface TS2, they are collectively referred to as main surface TS, when there is no need to particularly distinguish between the first end surface LS1 and the second end surface LS2, they are collectively referred to as end surface LS, and when there is no need to particularly distinguish between the first lateral surface WS1 and the second lateral surface WS2, they are collectively referred to as lateral surface WS.

It is preferable that the corner portions and ridge portions of the multilayer body 10 are rounded. The corner portions are portions where three surfaces of the multilayer body 10 intersect, and the ridge portions are portions where two surfaces of the multilayer body 10 intersect.

As shown in FIGS. 2 and 3, the multilayer body 10 includes a plurality of inner dielectric layers 20i and a plurality of internal electrode layers 30 that are laminated in the lamination direction T. The multilayer body 10 also includes, in the lamination direction T, an inner layer portion 100, and a first outer layer portion 201 and a second outer layer portion 202 that sandwich the inner layer portion 100.

The inner dielectric layers 20i of the inner layer portion 100 and the outer dielectric layers 20o of the outer layer portion 200 may include different component compositions because the functions required for the inner layer portion 100 and the outer layer portion 200 are different. For example, the inner dielectric layers 20i are required to have high dielectric constant, while the outer dielectric layers 20o are required to have high moisture resistance, weather resistance, and strength. Therefore, the dielectric layers of the inner layer portion 100 are described as inner dielectric layers 20i, and the dielectric layers of the outer layer portion 200 are described as outer dielectric layers 20o. However, when there is no need to particularly distinguish between the inner dielectric layers 20i and the outer dielectric layers 20o, they are collectively described as dielectric layers 20.

### Inner Layer Portion

FIG. 4 schematically shows the configuration of the inner layer portion 100. The inner layer portion 100 includes a plurality of inner dielectric layers 20i and a plurality of internal electrode layers 30. In the inner layer portion 100, the plurality of internal electrode layers 30 are opposed to each other with a corresponding one of the inner dielectric layers 20i interposed therebetween. The inner layer portion 100 generates capacitance and substantially defines and functions as a capacitor.

As the material of the dielectric layer 20, for example, a dielectric ceramic including BaTiO₃, CaTiO₃, SrTiO₃, or CaZrO₃ as a main component can be used. Furthermore, as the material of the dielectric layer 20, for example, a Mn compound, Fe compound, Cr compound, Co compound, or Ni compound may be added as a subcomponent.

The thickness of the inner dielectric layer 20i is not particularly limited, but is preferably, for example, about 0.2 μm or more and about 15 μm or less. By reducing the thickness of the inner dielectric layer 20i, it is possible to improve the capacitance.

### Outer Layer Portion

The first outer layer portion 201 is provided adjacent to the first main surface TS1 of the multilayer body 10, and the second outer layer portion 202 is provided adjacent to the second main surface TS2 of the multilayer body 10. More specifically, the first outer layer portion 201 is provided between the internal electrode layer 30 closest to the first main surface TS1 among the plurality of internal electrode layers 30 and the first main surface TS1, and the second outer layer portion 202 is provided between the internal electrode layer 30 closest to the second main surface TS2 among the plurality of internal electrode layers 30 and the second main surface TS2. The first outer layer portion 201 and the second outer layer portion 202 do not include the internal electrode layer 30.

The outer layer portion 200 is made of an insulating material. The first outer layer portion 201 and the second outer layer portion 202 can each include a plurality of outer dielectric layers 20o, but may include a single outer dielectric layer 20o. Furthermore, the outer dielectric layer 20o can include the same type of dielectric material as the inner dielectric layer 20i, but may include components different from the inner dielectric layer 20i depending on the required function.

### Internal Electrode Layer

The plurality of internal electrode layers 30 include a plurality of first internal electrode layers 31 and a plurality of second internal electrode layers 32. The plurality of first internal electrode layers 31 and the plurality of second internal electrode layers 32 are alternately provided in the lamination direction T of the multilayer body 10.

The first internal electrode layers 31 each include a counter electrode portion 311 and an extension electrode portion 312, and the second internal electrode layers 32 each include a counter electrode portion 321 and an extension electrode portion 322.

The counter electrode portion 311 and the counter electrode portion 321 are opposed to each other with a corresponding one of the inner dielectric layers 20i interposed therebetween in the lamination direction T of the multilayer body 10. The shapes of the counter electrode portion 311 and the counter electrode portion 321 are not particularly limited and may be, for example, rectangular or substantially rectangular. The counter electrode portion 311 and the counter electrode portion 321 are portions that generate capacitance and substantially define and function as a capacitor.

The extension electrode portion 312 extends from the counter electrode portion 311 toward the first end surface LS1 of the multilayer body 10 and is exposed at the first end surface LS1. The extension electrode portion 322 extends from the counter electrode portion 321 toward the second end surface LS2 of the multilayer body 10 and is exposed at the second end surface LS2. The length in the width direction W of the counter electrode portion 311 and the extension electrode portion 312 may be the same or different. Also, these lengths in the width direction W may gradually change toward the first end surface LS1 at which they are exposed. The length in the width direction W of the counter electrode portion 321 and the extension electrode portion 322 may be the same or different. Also, these lengths in the width direction W may gradually change toward the second end surface LS2 where they are exposed.

Thus, the first internal electrode layers 31 are connected to the first external electrode 41, and there is a gap between each of the first internal electrode layers 31 and the second end surface LS2 of the multilayer body 10, that is, the second external electrode 42. Also, the second internal electrode layers 32 are connected to the second external electrode 42, and there is a gap between each of the second internal electrode layers 32 and the first end surface LS1 of the multilayer body 10, that is, the first external electrode 41.

The first internal electrode layers 31 and the second internal electrode layers 32 include metal Ni as a main component, for example. Furthermore, the first internal electrode layers 31 and the second internal electrode layers 32 may include, for example, at least one of Cu, Ag, Pd, Sn or Au, or an alloy including at least one of these metals such as an Ag—Pd alloy, as the main component, or may include at least one of these as a component other than the main component. Furthermore, the first internal electrode layers 31 and the second internal electrode layers 32 may include dielectric particles having the same composition system as that of the ceramic included in the inner dielectric layer 20i, as a component other than the main component. In the present specification, a metal which is the main component indicates the metal component having the highest weight %.

The thickness of each of the first internal electrode layers 31 and each of the second internal electrode layers 32 is not particularly limited, but is, for example, preferably about 0.2 μm or more and about 2.0 μm or less, and more preferably about 0.30 μm or more and about 0.35 μm or less. The number of the first internal electrode layer 31 and the second internal electrode layer 32 is not particularly limited.

Methods for measuring the thickness of the inner dielectric layer 20i and the internal electrode layer 30 include, for example, a method of observing a WT cross section near the middle in the length direction L of the multilayer body exposed by polishing using a scanning electron microscope. Also, each value may be an average value of measurements at multiple locations in the width direction W, or may further be an average value of measurements at multiple locations in the lamination direction T.

As shown in FIG. 3, the multilayer body 10 includes, in the width direction W, an electrode counter portion W30 where the internal electrode layers 30 are opposed to each other, and a first side gap portion WG1 and a second side gap portion WG2 that sandwich the electrode counter portion W30. The first side gap portion WG1 is located between the electrode counter portion W30 and the first lateral surface WS1, and the second side gap portion WG2 is located between the electrode counter portion W30 and the second lateral surface WS2. More specifically, the first side gap portion WG1 is located between the end of each of the internal electrode layers 30 adjacent to the first lateral surface WS1 and the first lateral surface WS1, and the second side gap portion WG2 is located between the end of each of the internal electrode layers 30 adjacent to the second lateral surface WS2 and the second lateral surface WS2. The first side gap portion WG1 and the second side gap portion WG2 do not include any internal electrode layer 30, and include only the dielectric layers 20. The first side gap portion WG1 and the second side gap portion WG2 are also referred to as W gaps.

As shown in FIG. 2, the multilayer body 10 includes, in the length direction L, an electrode counter portion L30 where the first internal electrode layers 31 and the second internal electrode layers 32 of the internal electrode layer 30 are opposed to each other, a first end gap portion LG1, and a second end gap portion LG2. The first end gap portion LG1 is located between the electrode counter portion L30 and the first end surface LS1, and the second end gap portion LG2 is located between the electrode counter portion L30 and the second end surface LS2. More specifically, the first end gap portion LG1 is located between the end of each of the second internal electrode layers 32 adjacent to the first end surface LS1 and the first end surface LS1, and the second end gap portion LG2 is located between the end of each of the first internal electrode layers 31 adjacent to the second end surface LS2 and the second end surface LS2. The first end gap portion LG1 does not include any second internal electrode layer 32, and includes the first internal electrode layers 31 and the inner dielectric layers 20i, and the second end gap portion LG2 does not include any first internal electrode layer 31, and includes the second internal electrode layers 32 and the inner dielectric layers 20i. The first end gap portion LG1 is a portion that defines and functions as an extension electrode portion of each of the first internal electrode layers 31 toward the first end surface LS1, and the second end gap portion LG2 is a portion that defines and functions as an extension electrode portion of each of the second internal electrode layers 32 toward the second end surface LS2. The first end gap portion LG1 and the second end gap portion LG2 are also referred to as L gaps.

The counter electrode portions 311 of the first internal electrode layers 31 and the counter electrode portions 321 of the second internal electrode layers 32 described above are located in the electrode counter portion L30. Also, the extension electrode portions 312 of the first internal electrode layers 31 described above are located in the first end gap portion LG1, and the extension electrode portions 322 of the second internal electrode layers 32 described above are located in the second end gap portion LG2.

Methods for measuring the thickness of the multilayer body 10 include, for example, a method of observing, using a scanning electron microscope, an LT cross section near the middle in the width direction W of the multilayer body exposed by polishing, or a method of observing a WT cross section near the middle in the length direction L of the multilayer body exposed by polishing. Also, each value may be an average value of measurements at multiple locations in the length direction L or width direction W. Similarly, methods for measuring the length of the multilayer body 10 include, for example, a method of observing, using a scanning electron microscope, an LT cross section near the middle in the width direction W of the multilayer body exposed by polishing. Also, each value may be an average value of measurements at multiple locations in the lamination direction T. Similarly, methods for measuring the width of the multilayer body 10 include, for example, a method of observing, using a scanning electron microscope, a WT cross section near the middle in the length direction L of the multilayer body exposed by polishing. Also, each value may be an average value of measurements at multiple locations in the lamination direction T.

### External Electrode

The external electrodes 40 include the first external electrode 41 and the second external electrode 42.

The first external electrode 41 is provided on the first end surface LS1 of the multilayer body 10 and is connected to the first internal electrode layers 31. The first external electrode 41 may extend from the first end surface LS1 to a portion of the first main surface TS1 and a portion of the second main surface TS2. Also, the first external electrode 41 may extend from the first end surface LS1 to a portion of the first lateral surface WS1 and a portion of the second lateral surface WS2.

The second external electrode 42 is provided on the second end surface LS2 of the multilayer body 10 and is connected to the second internal electrode layers 32. The second external electrode 42 may extend from the second end surface LS2 to a portion of the first main surface TS1 and a portion of the second main surface TS2. Also, the second external electrode 42 may extend from the second end surface LS2 to a portion of the first lateral surface WS1 and a portion of the second lateral surface WS2.

The first external electrode 41 includes a base electrode layer 415 and a plated layer 416, and the second external electrode 42 includes a base electrode layer 425 and a plated layer 426. The first external electrode 41 may include only the plated layer 416, or the second external electrode 42 may include only the plated layer 426.

The base electrode layer 415 and the base electrode layer 425 may be fired layers including metal and glass, for example. Examples of the glass include glass components including at least one of B, Si, Ba, Mg, Al, Li, or the like. As a specific example, borosilicate glass can be used. The metal includes Cu as a main component, for example. Further, the metal may include at least one of Ni, Ag, Pd, or Au, or alloys such as Ag—Pd alloys as a main component, or may include them as components other than the main component.

The fired layer is a layer obtained by applying an electrically conductive paste including metal and glass to the multilayer body by a dipping method, and then firing. In addition, the firing may be performed after firing the internal electrode layer, or the firing may be performed simultaneously with the internal electrode layer. Furthermore, the fired layer may include a plurality of layers.

Alternatively, the base electrode layer 415 and the base electrode layer 425 may be, for example, resin layers including electrically conductive particles and a thermosetting resin. The resin layer may be provided on the above-described fired layer, or may be directly provided on the multilayer body without the fired layer.

The resin layer is a layer obtained by applying an electrically conductive paste including electrically conductive particles and a thermosetting resin to a multilayer body by a coating method, and then heating the paste. The resin layer may be fired after firing of the internal electrode layers, or may be fired simultaneously with firing of the internal electrode layers. The resin layer may include a plurality of layers.

The thickness of each layer of the base electrode layer 415 and the base electrode layer 425 defining and functioning as the fired layer or the resin layer is not particularly limited, and may be, for example, about 2 μm or more and about 220 μm or less.

Alternatively, the base electrode layer 415 and the base electrode layer 425 may be thin film layers of, for example, about 1 μm or less which are formed by a thin film formation method such as sputtering or vapor deposition, for example, and on which metal particles are deposited.

The plated layer 416 covers at least a portion of the base electrode layer 415, and the plated layer 426 covers at least a portion of the base electrode layer 425. The plated layer 416 and the plated layer 426 include, for example, at least one of Cu, Ni, Ag, Pd or Au, or an alloy such as an Ag—Pd alloy.

The plated layer 416 and the plated layer 426 may each include a plurality of layers. Preferably, for example, the plated layers 416 and 426 includes a two-layer configuration of Ni plating and Sn plating. The Ni plated layer can prevent the base electrode layer from being eroded by solder when mounting the ceramic electronic component, and the Sn plated layer improves the wettability of solder when mounting the ceramic electronic component, thus enabling easy mounting. The plated layer 416 and the plated layer 426 can also include, for example, a three-layer configuration by laminating Cu plating, Ni plating, and Sn plating, respectively. The outermost layer may be Au plating, for example.

The thickness per layer of each of the plated layer 416 and the plated layer 426 is not particularly limited, and may be, for example, about 1 μm or more and about 10 μm or less.

### Divided Region

FIG. 5 is an enlarged view of a region V shown in FIG. 3. The multilayer ceramic capacitor 1 according to the present example embodiment includes a region A at least at one of the end portions in the width direction W of the internal electrode layers 30 as a region having a lower line coverage than the middle portion in the width direction W of the internal electrode layer 30. The region A at the end portion in the width direction W of the internal electrode layers 30 includes internal electrode existing regions a1 and divided regions a2. Each of the internal electrode existing regions a1 is a region where the internal electrode layer exists, and each of the divided regions a2 is a region between two adjacent internal electrode existing regions a1 in the width direction W. That is, at the end portion in the width direction W of the internal electrode layers 30, the divided regions a2 are provided by dividing the internal electrode layer 30. Since the existence of the divided region of the internal electrode layer 30 affects the continuity of the internal electrode layer, it can be evaluated by measuring the line coverage of the internal electrode layer. That is, as the region occupied by the divided region increases, the line coverage of the internal electrode layer 30 has a lower value.

### Line Coverage

Line coverage is an index indicating the continuity of the electrically conductive components of each of the internal electrode layers. When comparing a first outer internal electrode layer E1 closest to the main surface TS of the multilayer body 10 and a second outer internal electrode layer E2 opposed to the first outer internal electrode layer E1 with a corresponding one of the dielectric layers 20 interposed therebetween, the line coverage at the end portion in the width direction W of the first outer internal electrode layer E1 is lower than the line coverage at the end portion in the width direction W of the second outer internal electrode layer E2, and at the end portion in the width direction W of the first outer internal electrode layer E1, there are more divided regions a2 provided by dividing the internal electrode layer compared to the end portion of the second outer internal electrode layer E2.

### Measurement of Line Coverage

The measurement of line coverage is performed by observing the WT cross-section of the multilayer ceramic capacitor in which the internal electrode layers are exposed. The line coverage at the end portions in the width direction W of all internal electrode layers 30, including the line coverage at the end portions in the width direction W of the first outer internal electrode layer E1 and the end portions in the width direction W of the second outer internal electrode layer E2, is measured. The measurement of line coverage is performed for the end portion adjacent to the first lateral surface WS1 of the internal electrode layer 30 and the end portion adjacent to the second lateral surface WS2 of the internal electrode layer 30. Here, the range from the end in the width direction W of the internal electrode layer 30 to about 20 μm towards the middle portion in the width direction W of the internal electrode layer 30 is measured as the range corresponding to the end portion in the width direction W of the internal electrode layer. The internal electrode layers 30 each include regions where the electrically conductive components exist and regions where the electrically conductive component does not exist. Line coverage is calculated as the ratio of the length in the width direction W of the region actually occupied by the electrically conductive components of the internal electrode layer relative to the length in the width direction W of the internal electrode layer when the presence or absence of the electrically conductive components is not considered in the SEM image, that is, the ratio of the length in the width direction W excluding the regions where the electrically conductive components do not exist relative to the length in the width direction W of the internal electrode layer when the presence or absence of the electrically conductive components is not considered in the SEM image. The magnification of the SEM may be, for example, about 1000 times or more and about 5000 times or less, but is preferably about 2000 times. In addition, conditions such as acceleration voltage and magnification are fixed during measurement.

### Segregation

At least at one of the end portions in the width direction W of the first outer internal electrode layer E1, there are divided regions a2 provided by dividing the internal electrode layer, and Mg or Mn is segregated in such divided regions a2. In FIG. 5, the portions where Mg or Mn is segregated are indicated by the symbol S.

Also, there are divided regions a2 at least at one of the end portions in the width direction W of the second outer internal electrode layer E2, and Mg or Mn is segregated here as well, but the second outer internal electrode layer E2 includes fewer divided regions a2 than the first outer internal electrode layer E1, and the amount of Mg or Mn segregated in the divided regions a2 of the second outer internal electrode layer E2 is less than the amount of Mg or Mn segregated in the divided regions a2 of the first outer internal electrode layer E1.

The type and amount of precipitate due to segregation can be confirmed, for example, by cutting the multilayer ceramic capacitor and performing wavelength dispersion X-ray analysis (WDX) on the WT cross-section where the internal electrode layers are exposed.

In the multilayer ceramic capacitor 1 according to the present example embodiment, high-temperature reliability is improved by lowering the line coverage at an end portion in the width direction W of the first outer internal electrode layer E1 closest to the main surface TS of the multilayer body 10 and segregating Mg or Mn in the divided regions at the end portion in the width direction W of the first outer internal electrode layer E1.

When the divided regions a2 are not provided in the internal electrode layer and Mg or Mn is segregated in the internal electrode existing regions a1, the thickness in the lamination direction T of the internal electrode layer 30 increases at the segregation portions, and as a result, the thickness of the dielectric layer 20 around the segregation portion becomes thinner, and high-temperature reliability decreases. To the contrary, as in the present example embodiment, when the divided regions a2 are provided in the internal electrode layer, Mg or Mn is segregated in the divided regions a2. Therefore, the thickness in the lamination direction T of the internal electrode layer does not increase, and the thickness of the dielectric layer 20 around the segregation portion can be maintained constant or substantially constant, such that high-temperature reliability is improved.

It is preferable to make the line coverage at the end portion in the width direction W of the first outer internal electrode layer E1 lower than any line coverage at the end portions in the width direction W of other internal electrode layers and to segregate more Mg or Mn in the divided regions a2 at the end portion in the width direction W of the first outer internal electrode layer E1, because the advantageous effect of improving high-temperature reliability is improved.

The line coverage at the end portion in the width direction W of the first outer internal electrode layer E1 is preferably about 76% or less, for example. When the line coverage exceeds about 76%, the divided regions a2 decrease, and Mg or Mn is segregated not only in the divided regions a2, but also in the dielectric layer 20, making it difficult to achieve the advantageous effects of Mg or Mn segregation. Also, Mg or Mn is segregated in the internal electrode existing regions a1, which also leads to a decrease in high-temperature reliability.

### Manufacturing of Multilayer Ceramic Capacitor

Next, an example of a method for manufacturing a multilayer ceramic capacitor according to an example embodiment of the present invention will be described.

First, a ceramic green sheet for forming dielectric layers and an electrically conductive paste for manufacturing internal electrodes are prepared. The electrically conductive paste for manufacturing internal electrodes includes a binder and a solvent, and known organic binders and organic solvents can be used. The electrically conductive paste for manufacturing internal electrodes forms internal electrode layers.

Next, the electrically conductive paste for manufacturing internal electrodes is printed in a predetermined pattern on the ceramic green sheet by, for example, screen printing or gravure printing, thus forming internal electrode patterns. By adjusting the thickness of the electrically conductive paste and printing, the internal electrode layers to be formed are adjusted to have a predetermined line coverage.

Next, a predetermined number of ceramic green sheets for manufacturing outer layers on which no internal electrode patterns are formed are laminated, ceramic green sheets on which internal electrodes are formed are sequentially laminated thereon, and a predetermined number of ceramic green sheets for manufacturing outer layers are laminated thereon to produce a multilayer sheet. The ceramic green sheets form the dielectric layers 20 that define the multilayer ceramic capacitor 1.

A multilayer block is produced by pressing the obtained multilayer sheet in the lamination direction T by, for example, hydrostatic pressing. Next, the multilayer block is cut to a predetermined size to cut out multilayer chips. At this time, corner portions and ridge portions of the multilayer chips may be rounded by, for example, barrel polishing or the like.

Furthermore, the multilayer body 10 is produced by firing the multilayer chips. The firing temperature at this time is, for example, preferably about 900° C. or more and about 1300° C. or less, although it depends on the materials of the dielectric and internal electrodes. By adjusting the oxygen concentration in the temperature range of, for example, about 900° C. or more and about 1300° C. or less, it is possible to provide more Mg or Mn segregated at the end portions in the width direction W of the first outer internal electrode layer E1 closest to the main surface.

Next, using a dipping method, for example, the first end surface LS1 of the multilayer body 10 is immersed in an electrically conductive paste, which is an electrode material for manufacturing the base electrode layer, to apply the electrically conductive paste for manufacturing the base electrode layer 415 to the first end surface LS1. Similarly, using a dipping method, for example, the second end surface LS2 of the multilayer body 10 is immersed in an electrically conductive paste, which is an electrode material for the base electrode layer, to apply the electrically conductive paste for the base electrode layer 425 to the second end surface LS2. Thereafter, these electrically conductive pastes are fired to form the base electrode layer 415 and the base electrode layer 425, which are fired layers. The firing temperature is, for example, preferably about 600° C. or more and about 900° C. or less.

As described above, for example, the base electrode layer 415 and the base electrode layer 425, which are resin layers, may be formed by applying an electrically conductive paste including electrically conductive particles and a thermosetting resin by a coating method and then heating, or the base electrode layer 415 and the base electrode layer 425, which are thin films, may be formed by a thin film formation method such as sputtering or vapor deposition.

Thereafter, the first external electrode 41 is formed by forming the plated layer 416 on the surface of the base electrode layer 415, and the second external electrode 42 is formed by forming the plated layer 426 on the surface of the base electrode layer 425. The multilayer ceramic capacitor 1 is obtained through the above steps.

Although example embodiments of the present invention have been described, the present invention is not limited to the example embodiments, and can be provided in various configurations without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of inner dielectric layers and a plurality of internal electrode layers alternately laminated in a lamination direction, outer layer portions sandwiching the inner layer portion in the lamination direction, two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction; and
a pair of external electrodes each on a corresponding one of the two end surfaces and each connected to the plurality of internal electrode layers; wherein
the plurality of internal electrode layers include a first outer internal electrode layer closest to one of the two main surfaces and a second outer internal electrode layer opposed to the first outer internal electrode layer;
a line coverage at an end portion in the width direction of the first outer internal electrode layer is lower than a line coverage at an end portion in the width direction of the second outer internal electrode layer; and
the first outer internal electrode layer further includes a divided region at the end portion at which Mg or Mn is segregated.

2. The multilayer ceramic capacitor according to claim 1, wherein the line coverage at the end portion of the first outer internal electrode layer is about 76% or less.

3. The multilayer ceramic capacitor according to claim 1, wherein the line coverage at the end portion of the first outer internal electrode layer is lower than any line coverage at end portions in a width direction of other internal electrode layers among the plurality of internal electrode layers.

4. The multilayer ceramic capacitor according to claim 1, wherein an amount of Mg or Mn segregated in a divided region at the end portion of the second outer internal electrode layer is less than an amount of Mg or Mn segregated in the divided region at the end portion of the first outer internal electrode layer.

5. The multilayer ceramic capacitor according to claim 1, wherein the line coverage at the end portion of the first outer internal electrode layer is lower than a line coverage in a middle portion of the first outer internal electrode.

6. The multilayer ceramic capacitor according to claim 1, wherein the first outer internal electrode layer includes a plurality of the divided regions at the end portion.

7. The multilayer ceramic capacitor according to claim 6, wherein the end portion of the second outer internal electrode layer in the width direction includes a plurality of divided regions in which Mg or Mn is segregated.

8. The multilayer ceramic capacitor according to claim 7, wherein a number of the plurality of divided regions in the second outer internal electrode layer is less than a number of the plurality of divided regions in the first outer internal electrode.

9. The multilayer ceramic capacitor according to claim 7, wherein an amount of Mg or Mn segregated in the plurality of divided regions in the second outer internal electrode layer is less than an amount of Mg or Mn segregated in the plurality of divided regions in the first outer internal electrode layer.

10. The multilayer ceramic capacitor according to claim 1, wherein each of the plurality of internal electrode layers includes at least one of Cu, Ag, Pd, Sn or Au, or an alloy including at least one of Cu, Ag, Pd, Sn or Au as a main component.

11. The multilayer ceramic capacitor according to claim 1, wherein a thickness of each of the plurality of internal electrode layers is about 0.2 μm or more and about 2.0 μm or less.

12. The multilayer ceramic capacitor according to claim 1, wherein a thickness of each of the plurality of internal electrode layers is about 0.30 μm or more and about 0.35 μm or less.

13. The multilayer ceramic capacitor according to claim 1, wherein each of the pair of external electrodes includes a base electrode layer and a plated layer on the base electrode layer.

14. The multilayer ceramic capacitor according to claim 13, wherein the base electrode layer includes metal and glass.

15. The multilayer ceramic capacitor according to claim 14, wherein the glass includes at least one of B, Si, Ba, Mg, Al, or Li.

16. The multilayer ceramic capacitor according to claim 14, wherein the metal includes at least one of Ni, Ag, Pd, or Au, or an alloy including at least one of Ni, Ag, Pd, or Au as a main component.

17. The multilayer ceramic capacitor according to claim 13, wherein a thickness of the base electrode layer is about 2 μm or more and about 220 μm or less.

18. The multilayer ceramic capacitor according to claim 13, wherein the plated layer includes at least one of Cu, Ni, Ag, Pd or Au, or an alloy including at least one of Cu, Ni, Ag, Pd or Au.
